(19) United States
(12) Patent Application Publication
(10) Pub. No.: US 2024/0279107 A1
(43) Pub. Date: Aug. 22, 2024

(54) GLASS FOR COVERING SEMICONDUCTOR ELEMENT AND MATERIAL FOR COVERING SEMICONDUCTOR ELEMENT USING THE SAME

(71) Applicant: NIPPON ELECTRIC GLASS CO., LTD, Otsu-shi, Shiga (JP)

(72) Inventor: Masayuki HIROSE, Otsu-shi, Shiga (JP)

(73) Assignee: NIPPON ELECTRIC GLASS CO., LTD, Otsu-shi, Shiga (JP)

(21) Appl. No.: 18/568,931

(22) PCT Filed: Jun. 6, 2022
(86) PCT No.: PCT/JP2022/022812

§ 371 Date: Dec. 11, 2023

(30) Foreign Application Priority Data
Jun. 14, 2021 (JP) 2021-098842
Mar. 4, 2022 (JP) 2022-033590

(51) Int. Cl. C03C 3/066; C03C 3/093; C03C 8/04

(52) U.S. Cl. CPC C03C 3/066; C03C 3/093; C03C 8/04

(57) ABSTRACT

Provided is a glass for covering a semiconductor element, which has a small environmental load, excellent acid resistance, and a low firing temperature. A glass for covering a semiconductor element containing, by mol %, from 28 to 48% of SiO₂, 3% or more and less than 10% of ZnO, from 5 to 25% of B₂O₃, from 10 to 25% of Al₂O₃, and from 8 to 22% of MgO+CaO as a glass composition, and containing substantially no lead component.

### TECHNICAL FIELD

The present invention relates to a glass for covering a semiconductor element and a material for covering a semiconductor element using the same.

### BACKGROUND ART

In a semiconductor element such as a silicon diode or a transistor, a surface including a P-N junction of the semiconductor element is generally covered with glass. This can help stabilize the surface of the semiconductor element and suppress deterioration in characteristics over time.

The glass for covering a semiconductor element is required to have the following characteristics: (1) the glass has a thermal expansion coefficient matching the thermal expansion coefficient of the semiconductor element for preventing occurrence of cracks or the like due to a difference in thermal expansion coefficient between the glass and the semiconductor element; (2) the glass can be covered at a low temperature (for example, 860° C. or lower) for preventing deterioration in characteristics of the semiconductor element; and (3) the glass does not contain impurities such as alkali components which adversely affect the surface of the semiconductor element.

Zinc-based glasses such as ZnO—B₂O₃—SiO₂-based glass, and lead-based glasses such as PbO—SiO₂—Al₂O₃-based glass and PbO—SiO₂—Al₂O₃—B₂O₃-based glass are conventionally known as the glass for covering a semiconductor element, and, at present, lead-based glasses such as PbO—SiO₂—Al₂O₃-based glass and PbO—SiO₂—Al₂O₃—B₂O₃-based glass are mainly used from the viewpoint of workability (see, for example, Patent Documents 1 to 4).

### CITATION LIST

### Patent Literature

Patent Document 1: JP S48-43275 A
Patent Document 2: JP S50-129181 A
Patent Document 3: JP H01-49653 B
Patent Document 4: JP 2008-162881 A

### SUMMARY OF INVENTION

### Technical Problem

However, the lead component of the lead-based glass is a component harmful to the environment. Since the zinc-based glass described above contains a small amount of a lead component or a bismuth component, it cannot be said that the zinc-based glass is completely harmless to the environment.

In addition, the zinc-based glass is inferior to the lead-based glass in chemical durability, and presents a problem that the zinc-based glass is likely to be eroded in an acid treatment step after formation of a covering layer. For this reason, it is necessary to further form a protective film on the surface of the covering layer and perform acid treatment.

On the other hand, an increase in content of SiO₂ in the glass composition results in improvements in acid resistance and reverse withstand voltage of the semiconductor element. However, due to a rise in the firing temperature for the glass, there is a possibility that the characteristics of the semiconductor element may be deteriorated in a covering step.

Accordingly, the present invention has been made in view of the above circumstances, and a technical issue thereof is to provide a glass for covering a semiconductor element, which has a small environmental load, excellent acid resistance, and a low firing temperature.

### Solution to Problem

As a result of diligent studies, the present inventor has found that the above issue can be solved by using SiO₂—B₂O₃—Al₂O₃—ZnO-based glass having a specific glass composition, and proposed the finding as the present invention. Specifically, the glass for covering a semiconductor element of the present invention is characterized by containing, by mol %, from 28 to 48% of SiO₂, 3% or more and less than 10% of ZnO, from 5 to 25% of B₂O₃, from 10 to 25% of Al₂O₃, and from 8 to 22% of MgO+CaO as a glass composition, and containing substantially no lead component. Here, the phrase “contains substantially no . . . ” means not intentionally adding the component as a glass component and does not mean completely excluding even an unavoidable impurity. This specifically means that the content of the component including an impurity is less than 0.1 mass %. Further, the “MgO+CaO” means a total content of MgO and CaO.

In the glass for covering a semiconductor element of the present invention, the content ranges of the respective components are regulated as described above, and thus the environmental load is small, the acid resistance is improved, and the firing temperature is likely to be lowered.

As a result, it is suitable for covering a semiconductor element.

The glass for covering a semiconductor element of the present invention preferably has a molar ratio of SiO₂/ZnO of 3.0 or more. Here, the “SiO₂/ZnO” is a value obtained by dividing the content of SiO₂ by the content of ZnO.

The material for covering a semiconductor element of the present invention preferably contains from 75 to 100 mass % of a glass powder made of the above glass for covering a semiconductor element and from 0 to 25 mass % of a ceramic powder.

The material for covering a semiconductor element of the present invention preferably has a thermal expansion coefficient of from 20×10⁻⁷/° C. to 55×10⁻⁷/° C. in a temperature range of from 30 to 300° C. Here, the “thermal expansion coefficient in a temperature range of from 30 to 300° C.” refers to a value as measured by a push rod type thermal expansion coefficient measuring device.

### Advantageous Effects of Invention

The present invention can provide a glass for covering a semiconductor element, which has a small environmental load, excellent acid resistance, and a low firing temperature.

### DESCRIPTION OF EMBODIMENTS

The glass for covering a semiconductor element according to an embodiment of the present invention is characterized by containing, by mol %, from 28 to 48% of SiO₂, 3% or more and less than 10% of ZnO, from 5 to 25% of B₂O₃, from 10 to 25% of Al₂O₃, and from 8 to 22% of MgO+CaO as a glass composition, and containing substantially no lead component. The reason for limiting the respective contents of the components as described above will be explained below. In the following description about the content of each component, “%” means “mol %” unless otherwise indicated. In the present specification, a numerical range expressed using “from” and “to” refers to a range including the numerical value before “to” as the minimum value and the numerical value after “to” as the maximum value.

SiO₂ is a network-forming component of the glass, and is a component that enhances acid resistance. The content of SiO₂ is preferably from 28 to 48%, from 30 to 46%, from 31 to 44%, from 32 to 42%, from 33 to 40%, and particularly preferably from 34 to 39%. Too small a content of SiO₂ is likely to reduce acid resistance and makes vitrification difficult. On the other hand, too large a content of SiO₂ increases the firing temperature of the glass, and may cause deterioration of the characteristics of the semiconductor element in the covering step.

ZnO is a component that stabilizes the glass. The content of ZnO is preferably 3% or more and less than 10%, 5% or more and less than 9.6%, and particularly preferably 6% or more and less than 9.2%. Too small a content of ZnO results in strong devitrification properties during melting, and makes it difficult to form a homogeneous glass. Meanwhile, too large a content of ZnO is likely to deteriorate acid resistance.

Too small SiO₂/ZnO is likely to cause phase separation of the glass and to deteriorate acid resistance. Therefore, the SiO₂/ZnO is preferably 3.0 or more, 3.2 or more, 3.3 or more, and particularly preferably 3.5 or more. On the other hand, too large SiO₂/ZnO increases the firing temperature of the glass and may cause deterioration of the characteristics of the semiconductor element in the covering step, and thus the SiO₂/ZnO is preferably 15 or less, 12 or less, and particularly preferably 10 or less.

B₂O₃ is a network-forming component of the glass, and is a component that enhances softening fluidity. The content of B₂O₃ is from 5 to 25%, preferably from 5 to 22%, and particularly preferably from 5 to 20%. Too small a content of B₂O₃ results in strong crystallinity, and the softening fluidity is impaired during covering, and uniform covering on the surface of the semiconductor element becomes difficult. Too large a content of B₂O₃ tends to decrease acid resistance.

Al₂O₃ is a component that stabilizes the glass. The content of Al₂O₃ is from 10 to 25%, preferably from 11 to 22%, and particularly preferably from 12 to 20%. Too small a content of Al₂O₃ makes vitrification difficult. Meanwhile, too large a content of Al₂O₃ is likely to result in too high a firing temperature.

MgO and CaO are components that lower the viscosity of the glass. MgO+CaO is from 8 to 22%, preferably from 9 to 21%, and particularly preferably from 10 to 20%. Too small MgO+CaO is likely to increase the softening temperature of the glass. On the other hand, too large MgO+CaO tends to cause too large a thermal expansion coefficient, and to deteriorate the acid resistance and the insulating property.

Preferable ranges of contents of MgO and CaO are as follows.

The content of MgO is preferably from 0 to 22%, from 4 to 22%, from 8 to 22%, from 9 to 21%, and particularly preferably from 10 to 20%.

The content of CaO is preferably from 0 to 22%, from 4 to 22%, from 8 to 22%, from 9 to 21%, and particularly preferably from 10 to 20%.

MgO+CaO+ZnO (a total content of MgO, CaO, and ZnO) is preferably from 13 to 31%, from 15 to 30%, from 17 to 29%, and particularly preferably 19 to 28%. Too small MgO+CaO+ZnO is likely to result in too high a firing temperature. On the other hand, too large MgO+CaO+ZnO tends to deteriorate acid resistance.

In addition to the above components, other components (for example, SrO, BaO, MnO₂, Bi₂O₃, Ta₂O₅, Nb₂O₅, CeO₂, and Sb₂O₃) may be contained in an amount of up to 7% (preferably up to 3%).

From the viewpoint of environmental aspects, the glass for covering a semiconductor element preferably contains substantially no lead component (for example, PbO or the like) and also contains substantially no F or Cl. In addition, the glass preferably contains substantially no alkali metal component (for example, LizO, Na₂O or K₂O) which adversely affects the surface of the semiconductor element.

The glass for covering a semiconductor element according to an embodiment of the present invention is preferably in the form of a powder, that is, a glass powder. The glass, when processed into a glass powder, can easily cover the surface of the semiconductor element using, for example, a paste method, an electrophoretic coating method, or the like.

An average particle size D₅₀ of the glass powder is preferably 25 μm or less, and particularly preferably 15 μm or less. Too large an average particle size D₅₀ of the glass powder makes it difficult to form a paste. In addition, it is also difficult to apply a paste by electrophoresis. The lower limit of the average particle size D₅₀ of the glass powder is not particularly limited, but is practically preferably 0.1 μm or more. The “average particle size D₅₀” is a value as measured on a volume basis, and refers to a value as measured by a laser diffraction method.

The glass for covering a semiconductor element according to an embodiment of the present invention can be obtained, for example, by blending raw material powders of the respective oxide components to prepare a batch, melting the batch at about 1500° C. for about 1 hour for vitrification, and forming (and thereafter pulverizing and classifying if necessary) the vitrified product.

The material for covering a semiconductor element according to an embodiment of the present invention contains a glass powder made of the glass for covering a semiconductor element, and may be mixed with a ceramic powder (for example, a cordierite powder) to form a composite powder, if necessary. The addition of a ceramic powder facilitates adjustment of the thermal expansion coefficient.

The material for covering a semiconductor element according to an embodiment of the present invention preferably contains from 75 to 100 mass % of a glass powder made of the above glass for covering a semiconductor element and from 0 to 25 mass % of a ceramic powder.

The content of the ceramic powder is preferably less than 25%, and particularly preferably less than 20%, based on 100 mass % of the composite powder. Too large a content of the ceramic powder impairs the softening fluidity of the glass, and makes it difficult to cover the surface of the semiconductor element.

An average particle size (D₅₀) of the ceramic powder is preferably 30 μm or less, and particularly preferably 20 μm or less. Too large an average particle size D₅₀ of the ceramic powder is likely to deteriorate the surface smoothness of the covering layer. The lower limit of the average particle size D₅₀ of the ceramic powder is not particularly limited, but is practically preferably 0.1 μm or more.

The material for covering a semiconductor element according to an embodiment of the present invention has a thermal expansion coefficient of preferably from 20×10⁻⁷/° C. to 55×10⁻⁷/° C., and particularly preferably from 30×10⁻⁷/° C. to 50×10⁻⁷/° C. in a temperature range of from 30 to 300° C. When the thermal expansion coefficient falls outside the above range, cracks, warpage, and the like are likely to occur due to the difference in thermal expansion coefficient from the semiconductor element.

For the material for covering a semiconductor element according to an embodiment of the present invention, a firing temperature is preferably 900° C. or lower, and particularly preferably 880° C. or lower. Too high a firing temperature is likely to impair the characteristics of the semiconductor element in the covering step.

For the material for covering a semiconductor element according to an embodiment of the present invention, a change in mass per unit area after an acid resistance test is preferably less than 1.0 mg/cm², 0.9 mg/cm² or less, 0.8 mg/cm² or less, and particularly preferably 0.7 mg/cm² or less. Here, the “acid resistance test” is a test in which a sample is press-molded into a size of about 20 mm in diameter and 4 mm in thickness, then fired at a temperature higher than the softening point by 27 to 30° C. to produce a sintered body, and the sintered body is immersed in 30% nitric acid at 80° C. for 1 minute.

### Examples

The present invention will be described in detail below based on examples. The following examples are merely exemplary. The present invention is not limited to the following examples in any way.

Table 1 indicates Examples of the present invention (Samples Nos. 1 to 6) and Comparative Examples (Samples Nos. 7 to 10).

TABLE 1

| Glass powder (mol %) | No. 1 | No. 2 | No. 3 | No. 4 | No. 5 | No. 6 | No. 7 | No. 8 | No. 9 | No. 10 |
|---|---|---|---|---|---|---|---|---|---|---|
| SiO₂ | 33 | 37 | 45 | 46 | 33 | 33 | 30 | 25 | 30 | 30 |
| ZnO | 9 | 9 | 5 | 9 | 9 | 9 | 11 | 28 | 15 | 20 |
| B₂O₃ | 22 | 18 | 12 | 16 | 21 | 22 | 20 | 15 | 18 | 18 |
| Al₂O₃ | 17 | 17 | 16 | 11 | 22 | 17 | 18 | 15 | 12 | 15 |
| MgO | 19 | 12 | 20 | 18 | 15 | 19 | 21 | 17 | 12 | 17 |
| CaO | 0 | 7 | 2 | 0 | 0 | 0 | 0 | 0 | 13 | 0 |
| MgO + CaO | 19 | 19 | 22 | 18 | 15 | 19 | 21 | 17 | 25 | 17 |
| MgO + CaO + ZnO | 28 | 28 | 27 | 27 | 24 | 28 | 32 | 45 | 40 | 37 |
| SiO₂/ZnO | 3.7 | 4.1 | 9.0 | 5.1 | 3.7 | 3.7 | 2.7 | 0.9 | 2.0 | 1.5 |
| Ceramic powder (mass %) | None | None | None | None | None | Cordierite 5 | None | None | None | None |
| Softening point (° C.) | 790 | 810 | 870 | 841 | 820 | 815 | 813 | 780 | 750 | 800 |
| Firing temperature (° C.) | 820 | 840 | 900 | 870 | 850 | 845 | 840 | 810 | 780 | 830 |
| Thermal expansion coefficient | 42 | 44 | 47 | 48 | 40 | 40 | 41 | 46 | 54 | 42 |
| (×10⁻⁷/° C.) | | | | | | | | | | |
| Acid resistance (mass change | 0.6 | 0.5 | 0.4 | 0.5 | 0.7 | 0.8 | 1.0 | 3.9 | 1.4 | 3.2 |
| per unit area: mg/cm²) | | | | | | | | | | |

Each of the samples was produced in the following manner. First, raw material powders were blended to give a glass composition in Table 1, thereby preparing a batch, and the batch was melted at 1500° C. for 1 hour for vitrification. Subsequently, the molten glass was formed into a film shape, pulverized with a ball mill, and classified with a 350-mesh sieve to give a glass powder having an average particle size D₅₀ of 12 μm. In Sample No. 6, the cordierite powder (average particle size D₅₀: 12 μm) was added in an amount shown in the table to the obtained glass powder to give a composite powder.

The samples were each evaluated for the thermal expansion coefficient, softening point, and acid resistance. The results are presented in Table 1.

The thermal expansion coefficient is a value as measured in a temperature range of from 30 to 300° C. using a push rod type thermal expansion coefficient measuring device.

The softening point was measured using a macro-type differential thermal analyzer. Specifically, in a chart obtained by measuring each glass powder sample using a macro-type differential thermal analyzer, the value of the fourth inflection point was taken as softening point. The firing temperature was from 27 to 30° C. higher than the softening point.

The acid resistance was evaluated as follows. Each sample was press-molded into a size of about 20 mm in diameter and 4 mm in thickness, then fired at a temperature higher than the softening point by 27 to 30° C. to produce a sintered body. The sintered body was immersed in 30% nitric acid at 80° C. for 1 minute. The mass loss after the 1 minute immersion was used to calculate a mass change per unit area. When the mass change per unit area was less than 1.0 mg/cm², the acid resistance was considered to be sufficient. When the change in mass per unit area was 1.0 mg/cm² or more, the acid resistance was considered to be insufficient.

As is clear from Table 1, Samples Nos. 1 to 6 had a thermal expansion coefficient from 40×10⁻⁷/° C. to 48×10⁻⁷/° C. and a firing temperature of 900° C. or lower, and their acid resistance was also evaluated as good. Therefore, it is considered that Samples Nos. 1 to 6 are suitable as the material for covering a semiconductor element. On the other hand, Samples Nos. 7 to 10 were inferior in acid resistance.

1. A glass for covering a semiconductor element, the glass comprising, by mol %, from 28 to 48% of SiO₂, 3% or more and less than 10% of ZnO, from 5 to 25% of B₂O₃, from 10 to 25% of Al₂O₃, and from 8 to 22% of MgO+CaO as a glass composition, and comprising substantially no lead component.

2. The glass for covering a semiconductor element according to claim 1, wherein a molar ratio of SiO₂/ZnO is 3.0 or more.

3. A material for covering a semiconductor element, comprising from 75 to 100 mass % of a glass powder made of the glass for covering a semiconductor element according to claim 1, and from 0 to 25 mass % of a ceramic powder.

4. The material for covering a semiconductor element according to claim 3, wherein the material has a thermal expansion coefficient of from 20×10⁻⁷/° C. to 55×10⁻⁷/° C. in a temperature range of from 30 to 300° C.
